(19) United States
(12) Patent Application Publication
(10) Pub. No.: US 2011/0318946 A1
(43) Pub. Date: Dec. 29, 2011

(54) Integrated Planar Electrical Connector For Personal Electronic Devices

(76) Inventor: David Sikorski, Toledo, OH (US)

(21) Appl. No.: 12/826,198

(22) Filed: Jun. 29, 2010

(51) Int. Cl. H01R 13/44

(52) U.S. Cl. 439/131

(57) ABSTRACT

A planar electrical connector is configured to be stowed within a personal electronic device. The planar electrical connector comprises a connector housing having a moveable support structure. The moveable support structure is configured to permit movement of the planar electrical connector relative to the personal electronic device between a use position and a stowed position. The connector housing configured to define a single plane of contact within a charging receptacle and support a positive electrical contact and a negative electrical contact.

### BACKGROUND OF THE INVENTION

This invention relates in general to electrical connectors for battery-powered electronic devices. In particular, this invention relates to a storable, compact planar electrical connector for recharging small or battery-powered electronic devices, referred to herein as personal electronic devices.

Battery-powered, personal electronic devices are pervasive through out modern life. Many personal electronic devices are provided with rechargeable batteries that reduce the environment burden of disposing of depleted batteries and provide the ability to be recharged. These devices may be recharged at home or in the automobile. Most of these devices are provided with a separate cord for recharging.

The recharging cord has a first end that connects to a plug outlet on the device and a second end that connects to a power outlet. In the case of portable power recharging, and in particular power outlets in an automobile, the recharging cords have a second end that communicates with a power outlet that is the same as or similar to a conventional cigarette lighter receptacle. While the separate recharging cords perform adequately, it would be desirable to have a relatively compact, storable charging plug that is integral with the electronic device.

### SUMMARY OF THE INVENTION

This invention relates to a planar electrical connector that is adapted to be stowed within a personal electronic device. The planar electrical connector comprises a connector housing having a moveable support structure. The moveable support structure is configure to permit movement of the planar electrical connector relative to the personal electronic device between a use position and a stowed position. The connector housing configured to define a single plane of contact within a charging receptacle. The connector housing supports a positive electrical contact and a negative electrical contact.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a perspective view of an embodiment of a storable planar electrical connector.

FIG. 2 is a perspective view of another embodiment of a storable planar electrical connector.

FIG. 3 is an exploded, perspective view of another embodiment of a planar electrical connector.

FIG. 4 is a perspective view of another embodiment of a planar electrical connector having a wired electrical connection.

FIG. 5 is a schematic elevational view of another embodiment of a planar electrical connector having an electrical contact patch connection.

FIG. 6A is an elevational view of the planar electrical connector of FIG. 3 entering a power receptacle.

FIG. 6B is an elevational view of the planar connector of FIG. 3 engaged in a contact position with the power receptacle.

FIG. 6C is an end view of the planar connector and power receptacle of FIG. 3.

FIG. 7 is a schematic elevational view of another embodiment of a storable planar electrical connector.

FIG. 8 is a schematic elevational view of another embodiment of a storable planar electrical connector having articulating segments.

### DETAILED DESCRIPTION OF THE PREFERRED EMBODIMENTS

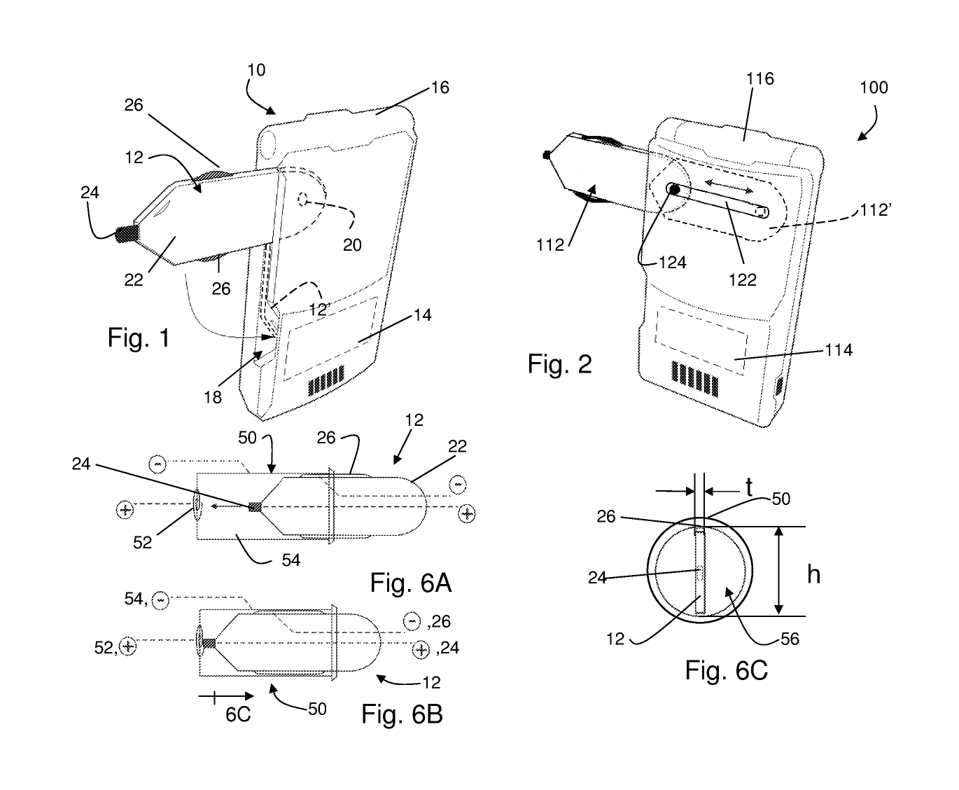

Referring now to the drawings, there is illustrated in FIG. 1 a personal electronic device (PED), shown generally at 10, having a storable planar electrical connector 12. The PED 10 may be any portable consumer electronic device such as, for example, a cell phone, a digital player/recorder device, and a personal digital assistant or PDA, or a music player, such as an MP3 formatted player or an iPod® player. Additionally, the PED 10 may be an electronic device not associated as a “personal” electronic device such as, for example, a flashlight, a voltage converter, fan, electronic air freshener, and the like. The storable planar electrical connector 12 provides selective electrical communication between a battery 14 of the PED 10 and a charging power source. The battery 14 may be any type of electrical power storage device, such as for example, a rechargeable battery or a capacitor. The storable planar electrical connector 12 may also serve to support the structure of the PED 10 relative to a charging receptacle.

The PED 10 includes a housing 16 shown having an optional stowage slot 18. The stowage slot 18 provides a protected recess to stow the storable planar electrical connector 12 when not in use. In the embodiment of FIG. 1, the PED housing 16 further includes a support structure, shown as a pivot pin 20, that supports the storable planar electrical connector 12 for rotation relative to the housing 16. The pivot pin 20 or the storable planar electrical connector 12 may have a detent or other structure that engages with the housing 12 to create a resistance to folding of the storable planar electrical connector 12 when the connector 12 is in use. The connector 12 may be rotated out of the slot 18 and into position at a generally right angle to the PED 10, as shown, or may be capable of further rotation, such as extending from the top of the PED 10 if desired. The storable planar electrical connector 12 may be biased into an opened position by a resilient member, as will be described below, or may be permitted to rotate freely to either the opened or closed position. Alternatively, the connector 12 may be biased into a closed position if desired.

Referring now to FIG. 2, there is illustrated another embodiment of a PED 100 having a storable planar electrical connector 112. The PED 100 includes a battery 114 and a housing 116. The storable planar electrical connector 112 is configured to extend and retract along a generally linear path relative to the housing 116. In one embodiment, the planar electrical connector 112 may include another moveable support structure, shown as a slide mechanism that includes a slide button 124 that cooperates with a slide groove 122 formed into the housing 116. Similar to the previous embodiment, the storable planar electrical connector 112 may have a detent associated with a portion of the slide mechanism to provide resistance when moving the planar electrical connector 112 from one of the extended position or retracted position to the other position. Additionally, the connector 112 may be pivotable relative to the housing 116 when extended substantially to the end of travel of the slide mechanism.

In an alternative embodiment of the PED 100, a storable planar electrical connector, similar to the connector 112, may be completely detachable from the PED 10. The alternative connector may have a plug end that is adapted to engage a charging receptacle of the PED. The alternative connector may be removed from the storage slot and plugged into the charging receptacle of the PED and the charging receptacle of, for example, a vehicle.

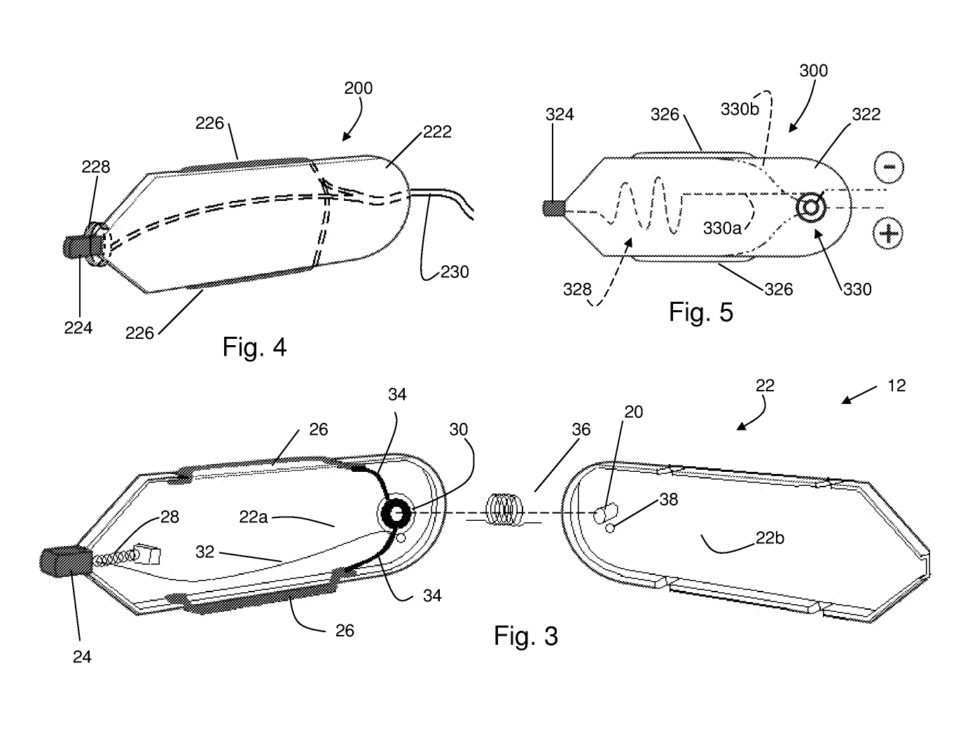

Referring now to FIG. 3, there is illustrated an exploded view of the storable planar electrical connector 12. The illustrated embodiment of the storable planar electrical connector 12 includes a two-piece connector blade housing 22, having two sides 22a and 22b that cooperate to form the housing 22, a positive electrical contact 24, and at least one negative or grounded electrical contact 26. In the illustrated embodiment, two spaced-apart negative contacts 26 are shown. The blade housings 22a and 22b define a cavity therein that carry the electrical connections between the contacts 24 and 26 and the PED 10. The blade housings 22a and 22b locate and support the positive and negative electrical contacts 24 and 26 for relative movement therewith.

The positive electrical contact 24 is illustrated as a projection that is resiliently biased in an extended position by a spring element 28. The negative electrical contacts 26 are illustrated as generally elongated contacts that are biased to extend outwardly from the housing 22. The negative electrical contacts 26 are also illustrated as resilient members that provide the outward bias and extend outward from the housing to sufficiently make contact with an inner diameter of a charging receptacle 50, such as is shown in FIGS. 6A-C. It should be understood that the positive and negative contacts 24 and 26 may be configured other than illustrated and remain within scope of this invention. For example, the positive contact 24 may have an external resilient member to bias the contact tip outwardly or may not be resiliently biased. The negative contact 26 may alternatively be configured, for example, as compressible wheels (not shown) that provide rolling contact and may deform slightly when entering the charging receptacle 50.

In the embodiment of FIG. 3, the positive and negative contacts 24 and 26 are in electrical communication with a slip ring 30. As shown in FIG. 3, the electrical communication can be maintained by way of an internal wire 32 and contact extensions 34 that are connected to the slip ring 30. The slip ring 30 includes contact points, shown as concentric circular strips, that are electrically connected to the positive and negative contacts 24 and 26. The slip ring 30 permits the contacts 24 and 26, for example, to remain in electrical communication with the battery 14 (or 114) throughout the range of motion, either rotary or sliding motion, of the storable planar electrical connector 12 (or 112). It should be understood that the slip ring 30 may be any suitable electrical contacting device desired. The storable planar electrical connector 12 (or 112) may further include a resilient member 36 that engages both the connector blade housing 22 and the PED housing 16 to bias the storable planar electrical connector 12 either in a use position or a stowed position (12′ or 112′), as shown in FIGS. 1 and 2. In the embodiment of the two-piece storable planar electrical connector 12 of FIG. 3, the ends of the resilient member 36 may extend through apertures 38 formed in the housing halves 22a and 22b and into engagement with the housing 16 of the PED 10.

Referring now to FIG. 4, there is illustrated another embodiment of a storable planar electrical connector, shown generally at 200. The planar electrical connector 200 is illustrated having a solid housing 222. A wire 230 provides electrical communication between positive and negative contacts 224 and 226 and the battery 14 (or 114). The wire 230 may be integrally molded within the housing 222 or positioned, bonded or otherwise affixed to the side of the housing 222. The positive contact 224 is shown being supported, in part, by an optional resilient member 228 that is partially exposed and partially embedded in the housing 222. The resilient member 228 may bias the positive contact 224 in an extended position, if so desired.

Referring now to FIG. 5, another embodiment of a storable planar electrical connector is shown generally at 300. The storable planar electrical connector 300 includes a housing 322, a positive contact 324 and at least one negative contact 326. The storable planar electrical connector 300 may also include a slip ring 330 to provide electrical communication between a battery, such as battery 14, and the positive and negative contacts 324 and 326, respectively. Alternatively, one or more wires, similar to wire 230 described above, may be used if desired. The positive contact may be resiliently supported by a first wire element 330a that provides both electrical communication and a resilient bias to the positive contact 324. The first wire element 330a may have a resilient section 328 formed therein. A second wire element 330b provides at least electrical communication between the slip ring 330 and the negative contact 326. Alternatively, the second wire element 330b may provide a resilient component to outwardly bias the negative contacts 326 if desired.

The housing 322 may be partially solid and configured to partially encapsulate a portion of the first and second wire elements 330a and 330b. Such a partial encapsulation may provide a cavity disposed around the resilient section 328 to permit free movement of the positive contact 324. Thus, the housing 322 may have a “C”-shaped cross section, if desired.

Referring now to FIGS. 6A, 6B, and 6C, the storable planar electrical connector 12 is illustrated engaging the charging receptacle 50, such as an automotive-type cigarette lighter or a 12-volt vehicular power connection. While the operation of the storable planar electrical connector 12 is described with relationship to the first embodiment, each of the embodiments may be operated in a similar manner. Furthermore, each of the elements of the various embodiments described herein may be substituted into any of the other embodiments and remain within the scope of the invention. The storable planar electrical connector 12 is configured to be disposed within the charging receptacle 50 which may be a cigarette lighter or dedicated power charging receptacle.

The charging receptacle 50 may include a positive power contact 52 that is configured to supply a source of electrical power to the PED 10 such as, for example, a 12 volt source of power. An outer jacket or can 54 provides a grounding source to complete the electrical circuit between the charging receptacle 50 and the PED 10. The charging receptacle 50 may be configured as a cylindrical electrical receptacle having a bore 56. The bore 56 may be any size or may be sized similar to conventional cigarette lighters known in the art. Such convention lighter receptacles are commonly provided as “type A” receptacles, having an inside diameter of approximately 21 mm, or “type B” receptacles, having an inside diameter of approximately 21.5 mm.

As shown in FIG. 6C, the planar electrical connector 12 has a thickness “t” and a height “h”. The thickness, t may be any dimension that permits insertion into the charging receptacle 50 yet is substantially smaller that the dimension of the height, h. In one embodiment, the thickness may be within the range of approximately 1/16th of an inch to approximately 3/16th of an inch. The planar electrical connector 12 may also have a height, h that is dimensioned to have flexibility within the height of the outside contacts to provide a height range of approximately 20.9 mm to 21.4 mm.

In one embodiment of the planar electrical connector 12, the negative contacts 26 are configured as linear contacting elements that occupy a substantial portion of the linear length of the housing 22. The linear length portion of the housing 22 that the negative contacts 26 are adjacent to may be defined by the generally parallel portions of the housing 22 at the outer bounds of the height, h. The negative contacts 26 are outwardly biased to provide a stabilizing force against the inner diameter of the charging receptacle 50. Additionally, the length of the negative contacts 26 distribute the load over a substantially planar length portion of the bore 56. The negative contacts 26 may have a thickness that is the same as or slightly smaller than the thickness, t of the planar contact 12.

As shown in FIG. 6C, the housing 22 of the planar electrical connector 12 is configured to define a single plane of contact within the bore 56 of the charging receptacle 50. The planar electrical connector 12 relies on this single plane of contact to provide a stable environment to support both the PED 10 and maintain proper electrical contact with the charging receptacle 50.

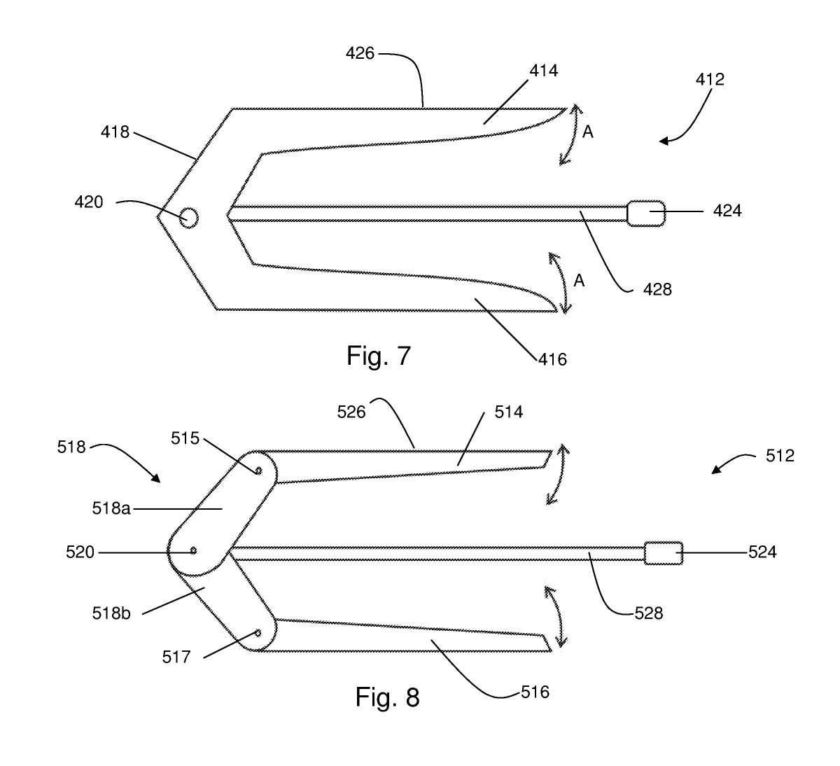

Referring now to FIG. 7 there is illustrated another embodiment of a storable planar electrical connector, shown schematically at 412. The connector 412 may be mounted for sliding or rotational movement relative to a housing, such as housing 16 above. The connector 412 includes a pair of arms 414 and 416 that extend lengthwise and are configured to support at least one negative contact 426. A positive contact 424 is shown mounted on a center post 428. The center post 428 may be a resilient structure that biases the positive contact 424 toward the contact 52 of the charging receptacle 50. Alternatively, the center post 428 may be substantially rigid if desired.

The arms 414 and 416 extend from a center frame 418 and are integrally formed therewith. The center frame 418 also provides a pivot pin 420 that may also be configured as a slip ring to provide electrical communication between the contacts 424 and 426 and the battery. The pivot pin 420 may be configured for sliding or rotational movement as described above. The arms 414 and 416 are resiliently mounted to the center frame 418 and may deflect as shown by arrows “A” in order to be outwardly biased and stabilize the connector 412 within the charging receptacle 50. As the connector 412 is inserted into the charging receptacle 50, the arms 414 and 416 are free to deflect inwardly and thus generate an outwardly biased stabilizing force to secure the connector 412 within the charging receptacle 50.

Referring now to FIG. 8, there is illustrated another embodiment of a storable planar electrical connector, shown generally at 512. The connector 512 includes two spaced-apart arms 514 and 516 that are pivotally connected to a center frame 518 by arm pivots 515 and 517. The pivot arms 514 and 516 include negative contacts 526, similar to those described above. The pivots 515 and 517 may include a resilient member that biases the arms 514 and 516 into an outwardly deployed position The center frame 518 is illustrated having a pivot pin 520 that supports frame arms 5188a and 518b for relative pivotal movement. The pivot pin 520 may also include a resilient member that biases the frame arms 518a,b away from each other. The range of outward motion of the frame arms 518a,b may be limited such that the arms 514 and 516 are generally deployed to be received within the charging receptacle 50. The arms 514 and 516 may also be biased to secure the connector 512 with the receptacle. The pivot pin 520 may also include a slip ring that supports a positive contact 524 and a center post for electrical communication with the battery.

The connector 512 may be folded to a compact position for storage. As the connector 512 is retracted into a housing, similar to housing 16 or 116, the arms 514 and 516 and center frame arms 518a and 518b may fold along the center post 528 to provide a compact storage package.

The principle and mode of operations of this invention have been explained and illustrated in its preferred embodiment. However, it must be understood that this invention may be practiced otherwise than as specifically explained and illustrated without departing from its spirit or scope.

What is claimed is:

1. A planar electrical connector configured to be stowed within a personal electronic device, the planar electrical connector comprising:
a connector housing configured to attach and permit movement of the planar electrical connector relative to the personal electronic device between a use position and a stowed position, the connector housing configured to define a single plane of contact within a charging receptacle;
a positive electrical contact; and
a negative electrical contact.

2. The planar electrical connector of claim 1 wherein the moveable support structure includes a pivot pin that provides for relative rotational movement between the planar electrical connector and the personal electronic device.

3. The planar electrical connector of claim 1 wherein the moveable support structure includes a slide button and a cooperating slide groove configured to extend and retract along a generally linear path relative to the personal electronic device.

4. The planar electrical connector of claim 1 wherein the connector housing is a two piece housing defining a cavity therein.

5. The planar electrical connector of claim 1 wherein the connector housing is a solid, one piece housing.

6. The planar electrical connector of claim 4 wherein the at least one negative electrical contact and the positive electrical contact are resiliently supported by the connector housing and the cavity includes a resilient member to bias the connector housing into one of the use position and the stowed position.

7. The planar electrical connector of claim 1 wherein the connector housing supports a slip ring that is in electrical communication with the positive electrical contact and the negative electrical contact.

8. The planar electrical connector of claim 1 wherein the connector housing includes a pair of spaced-apart, resiliently mounted arms configured to support the negative electrical contact and a center post configured to support the positive electrical contact, the arms being integrally formed with and extending from a center frame.

9. The planar electrical connector of claim 1 wherein the connector housing includes a pair of spaced-apart, resiliently mounted arms configured to support the negative electrical contact and a center post configured to support the positive electrical contact, the arms being pivotally connected to a center frame.

10. A personal electronic device comprising:
a housing having a stowage slot, the housing configured to support a battery; and
a planar electrical connector having a connector housing and a moveable support structure, the moveable support structure being configured to permit movement of the planar electrical connector relative to the housing between a use position and a stowed position, the connector housing configured to define a single plane of contact within a charging receptacle.

11. The personal electronic device of claim 10 wherein the connector housing supports at least one negative electrical contact and a positive electrical contact.

12. The personal electronic device of claim 11 wherein a slip ring maintains the planar electrical connector in electrical communication with the battery.

13. The personal electronic device of claim 12 wherein the connector housing of the planar electrical connector includes a cavity and a wire connecting the positive and negative electrical contacts to the slip ring.

14. The personal electronic device of claim 10 wherein the moveable support structure includes a pivot pin that provides for relative rotational movement between the planar electrical connector and the personal electronic device housing.

15. The personal electronic device of claim 10 wherein the moveable support structure includes a slide button and a cooperating slide groove configured to extend and retract along a generally linear path relative to the personal electronic device housing.

16. The personal electronic device of claim 10 wherein a resilient member cooperates with the personal electronic device housing and the planar electrical connector to bias the connector housing into one of the use position and the stowed position.

17. The personal electronic device of claim 11 wherein the negative electrical contact is a resilient negative electrical contact and the connector housing is a two-piece housing that supports the negative electrical contact.

18. The personal electronic device of claim 11 wherein the connector housing includes a pair of resiliently mounted arms that support the negative electrical contact and a center post that supports the positive electrical contact.

19. The personal electronic device of claim 18 wherein the resiliently mounted arms are pivotally mounted relative to a center frame.

20. The personal electronic device of claim 10 wherein the personal electronic device is a portable electronic device comprising one of a cell phone, a personal digital assistant, and a music player.
